(19) United States
(12) Patent Application Publication
(10) Pub. No.: US 2016/0124131 A1
(43) Pub. Date: May 5, 2016

(54) OPTICALLY ANISOTROPIC FILM AND METHOD FOR PRODUCING OPTICALLY ANISOTROPIC FILM

(71) Applicant: Sumitomo Chemical Company, Limited, Tokyo (JP)

(72) Inventors: Tadahiro KOBAYASHI, Osaka-shi (JP); Akira YOKOTA, Osaka-shi (JP)

(21) Appl. No.: 14/924,112

(22) Filed: Oct. 27, 2015

(30) Foreign Application Priority Data
Oct. 31, 2014 (JP) 2014-222660

(51) Int. Cl. G02B 5/30

(52) U.S. Cl. CPC G02B 5/3016

(57) ABSTRACT

In a conventional optically anisotropic film, striped unevenness parallel to the carrying direction of a substrate (the direction in which the substrate flows when the optically anisotropic film is produced in a roll-to-roll manner) is sometimes generated. In addition, when a liquid crystal cured film is transferred to a body to be transferred, uniformity of the liquid crystal cured film after transfer is sometimes also not sufficiently satisfactory. An optically anisotropic film is now formed by laminating a substrate, an orientation film and a liquid crystal cured film in this order, the substrate satisfying the following formula (A):

0<X_{A}<d_{X}/10 (A)

wherein X_{A} is a maximum height of the surface irregularity in the substrate, and dₓ represents an average thickness of the substrate.

### BACKGROUND OF THE INVENTION

1. Field of the Invention

The present invention relates to an optically anisotropic film.

2. Description of the Related Art

A flat panel display device (FPD) makes use of a member including an optical film such as a polarizing plate or a retardation plate. As such an optical film, known is an optically anisotropic film including a liquid crystal cured film made of a polymerizable liquid crystal compound. JP-W-2010-537955 describes an optically anisotropic film containing a liquid crystal cured film showing a reverse-wavelength dispersion property.

### SUMMARY OF THE INVENTION

In a conventional optically anisotropic film, striped unevenness parallel to the carrying direction of a substrate (the direction in which the substrate flows when the optically anisotropic film is produced in a roll-to-roll manner) is sometimes generated. In addition, when a liquid crystal cured film is transferred to a body to be transferred, uniformity of the liquid crystal cured film after transfer is not also sometimes sufficiently satisfactory.

The present invention encompasses the following inventions.

[1] An optically anisotropic film formed by laminating a substrate, an orientation film and a liquid crystal cured film in this order, the substrate satisfying the following formula (A)

0<X_{A}<dₓ/10 (A)

wherein X_{A} is a maximum height of the surface irregularity in the substrate, and dₓ represents an average thickness of the substrate.
[2] The optically anisotropic film according to [1], wherein the substrate has a thickness of 10 to 500 μm.
[3] The optically anisotropic film according to [1] or [2], wherein the substrate has a glass transition temperature (T_{g}) of 90° C. or more.
[4] The optically anisotropic film according to any of [1] to [3], wherein the liquid crystal cured film has a thickness of 0.05 to 5 μm.
[5] The optically anisotropic film according to any of [1] to [4], wherein the sticking force between the liquid crystal cured film and the orientation film layer or the sticking force between the orientation film layer and the substrate is 0.5 N/25 mm or less.
[6] The optically anisotropic film according to any of [1] to [5], wherein the liquid crystal cured film satisfies a formula (1) and a formula (2).

Re(450)/Re(550)≦1.00 (1)

1.00≦Re(650)/Re(550) (2)

wherein Re (450), Re (550) and Re (650) represent in-plane retardation values for the light at wavelengths of 450 nm, 550 nm and 650 nm, respectively.
[7] A method for producing an optically anisotropic film comprising laminating a substrate, an orientation film and a liquid crystal cured film in this order, the substrate satisfying the following formula (A),

0<X_{A}<d_{X}/10 (A)

wherein X_{A} is a maximum height of the surface irregularity in the width direction of the substrate, and dₓ represents an average thickness of the substrate,

the method comprising the steps (1) to (3).

Step (1): forming an orientation film on a substrate, and forming a liquid crystal coating film on the orientation film
Step (2): drying the liquid crystal coating film
Step (3): photoirradiating the liquid crystal coating film to obtain a liquid crystal cured film
[8] The method for producing an optically anisotropic film according to [7], wherein the drying temperature (Tₐ) in the step (2) satisfies the following formula (B),

Tₐ<T_{g}+50° C. (B)

wherein Tₐ represents a drying temperature, and T_{g} represents a glass transition temperature of the substrate.
[9] The method for producing an optically anisotropic film according to [7] or [8], wherein the method continuously carries out the process comprising the steps (1) to (3) while winding off the substrate from a roll, using the roll of an elongated film as the substrate,

the optically anisotropic film being formed by applying tension P_{B} satisfying the following formula (C) in the direction orthogonal to the carrying direction of the film, in the step (2) or step (3),

0<P_{B}<P_{A}/2 (C)

wherein P_{A} is a tension in a direction parallel to the substrate carrying direction, and P_{B} represents a tension in a direction perpendicular to the substrate carrying direction.
[10] A method for producing a laminated body containing a liquid crystal cured film, a sticky adhesive layer, and a body to be transferred,

comprising a step of adhering the liquid crystal cured film and the body to be transferred in the optically anisotropic film as defined in [1] to [6] with the sticky adhesive layer interposed therebetween, and a step of removing a layer containing the substrate in the optical film.

[11] A display device equipped with the optically anisotropic film as defined in [1] to [6].
[12] A display device equipped with a laminated body obtained by the method for producing a laminated body as defined in [10].

According to the present invention, an optically anisotropic film without unevenness can be formed, and gives excellent uniformity in the liquid crystal cured film after transfer.

### BRIEF DESCRIPTION OF THE DRAWINGS

FIG. 1 is schematic diagrams of a circularly polarizing plate having a liquid crystal cured film;

FIG. 2 is schematic diagrams of a liquid crystal display device including a circularly polarizing plate having a liquid crystal cured film; and

FIG. 3 is a schematic diagram of an organic EL display device including a circularly polarizing plate having a liquid crystal cured film.

### DETAILED DESCRIPTION OF THE PREFERRED EMBODIMENTS

The optically anisotropic film of the present invention is formed by laminating a substrate, an orientation film, and a liquid crystal cured film, in this order. Hereinbelow, each of the members constituting the optically anisotropic film will be described.

### <Substrate>

In the present invention, a substrate satisfies the following formula (A),

0<X_{A}<d_{X}/10 (A)

wherein X_{A} is a maximum height of the surface irregularity in the substrate, and dₓ represents an average thickness of the entire substrate.

In the substrate surface, the substrate preferably satisfies the formula (A) in the region of 70% or more, more preferably satisfies the formula (A) in the region of 90% or more, and further preferably satisfies the formula (A) in the region of 99% or more.

An example of the measurement methods of X_{A} will be described. First, a layer other than the substrate is peeled from the optical anisotropic film to obtain the substrate. Then, the surface on which the orientation film has been laminated in the substrate is separated by a region of 10 cm² as a unit. For example, when the substrate is a 10 cm square, it is 10 units. It is preferred to separate the substrate so as not to leave waste pieces (margin) as much as possible.

Maximum height X_{A}, of the surface irregularity in each unit is measured, and the ratio of the unit satisfying the formula (A) is obtained by the following formula, and defined as the ratio of the region satisfying the formula (A′).

(Number of units satisfying formula (A)/Number of all units)×100(%) (A′)

For example, when three units among all four units satisfy the formula (A), it is said that the formula (A) is satisfied in 75% of the region.

By using the substrate as described above, particularly in the step of drying the liquid crystal coating film described later (step (2)), deformation of the substrate is suppressed, thus smoothness of the formed liquid crystal cured film is improved, and an optically anisotropic film without unevenness can be obtained.

The maximum height X_{A} of the substrate surface irregularity can be measured in accordance with JIS B0601 '2001, and measured by an interference thickness meter, a laser microscope, a feeler-type film thickness meter, or non-contact surface layer section shape measuring system (for example, VertScan, manufactured by Hitachi High-Tech Science Corporation). Here, when the substrate surface is wavy, X_{A}, is the maximum height difference.

In the formula (A), X_{A} is preferably less than d_{X}/100, and more preferably less than d_{X}/1000.

The substrate may be a single layer, or may consist of a plurality of layers obtained by laminating two or more layers. In the step of drying the liquid crystal coating film described later (step (2)), the thickness of the substrate is usually 10 to 500 μm, preferably 15 to 400 μm, and more preferably 20 to 300 μm, in that unevenness is unlikely to be caused in the substrate. The thickness of the substrate is further preferably 40 μm or more, particularly preferably 60 μm or more, and further preferably 200 μm or less.

The substrate includes glass substrates and plastic substrates, and is preferably a plastic substrate. Examples of plastic constituting the plastic substrate include plastics such as polyolefins such as polyethylene, polypropylene, and norbornene polymers; cyclic olefin resins; polyvinyl alcohols; polyethylene terephthalate; polymethacrylic acid ester; polyacrylic acid ester; cellulose esters such as triacetyl cellulose, diacetyl cellulose, and cellulose acetate propionate; polyethylene naphthalate; polycarbonate; polysulfone; polyether sulfone; polyether ketone; polyphenylenesulfide, and polyphenyleneoxide. Preferred are plastics such as cellulose esters, cyclic olefin resins, polycarbonate, polyethylene terephthalate, and polymethacrylic acid ester.

Cellulose esters have the hydroxyl groups of cellulose at least partially esterified, and they are easily available in the market. Cellulose ester substrates are also easily available in the market. Examples of commercially available cellulose ester substrates include “Fuji TAC film” (Fuji Photo Film Co., Ltd.); and “KC8UX2M”, “KC8UY”, “KC4UY” (Konica Minolta Opto Products Co., Ltd.), and the like.

Cyclic olefin resins are formed of polymers or copolymers of cyclic olefins (cyclic olefin resins), such as norbornene and polycyclic norbornene monomers. Such a cyclic olefin resin may partially have an opened ring. In addition, it may also be obtained by hydrogenating a cyclic olefin resin having an opened ring. Further, in terms of not significantly damaging transparency or not significantly increasing hygroscopicity, the cyclic olefin resin may also be a copolymer of a cyclic olefin and a linear olefin or a vinylated aromatic compound (styrene, etc.). The cyclic olefin resin may also have a polar group introduced into the molecule.

In the case where the cyclic olefin resin is a copolymer of a cyclic olefin and a linear olefin or an aromatic compound having a vinyl group, the content of structural units derived from the cyclic olefin is usually 50% by mol or less, and preferably 15 to 50% by mol, based on the total structural units of the copolymer. Examples of the linear olefin include ethylene and propylene, and examples of the aromatic compound having a vinyl group include styrene, α-methylstyrene, and alkyl-substituted styrenes. In the case where the cyclic olefin resin is a ternary copolymer of a cyclic olefin, a linear olefin, and an aromatic compound having a vinyl group, the content of structural units derived from the linear olefin is usually 5 to 80% by mol, based on the total structural units of the ternary copolymer, and the content of structural units derived from the aromatic compound having a vinyl group is usually 5 to 60% by mol, based on the total structural units of the ternary copolymer. Such a ternary copolymer is advantageous in that, in its production, the usage of expensive cyclic olefin can be relatively reduced.

Examples of commercially available the cyclic olefin resin include “Topas” (registered trademark) [Ticona Corporation (Germany)], “ARTON” (registered trademark) [JSR Corporation], “ZEONOR” (registered trademark) [Zeon Corporation], “ZEONEX” (registered trademark) [Zeon Corporation], and “APEL” (registered trademark) [manufactured by Mitsui Chemicals, Inc.]. Such a cyclic olefin resin can be formed into a film by a known technique, such as solvent casting or melt extrusion, and used as a substrate. It is also possible to use a commercially available cyclic olefin resin substrate. Examples of the commercially available cyclic olefin resin substrate include “ESCENA” (registered trademark) [Sekisui Chemical Co., Ltd.], “SCA40” (registered trademark) [Sekisui Chemical Co., Ltd.], “ZEONOR Film” (registered trademark) [Optes Co., Ltd.], and “ARTON Film” (registered trademark) [JSR Corporation].

The substrate more preferably has a glass transition temperature (T_{g}) of 90° C. or more. The glass transition temperature T_{g} of the substrate is a temperature in which a molecular main chain starts or stops rotation and oscillation while the relative position of the polymer molecules forming the substrate does not change, and is sometimes referred to as a second-order transition point. The glass transition temperature T_{g} can be measured by the method in accordance with JIS K7121.

For the substrate having a glass transition temperature of 90° C. or more, a commercially available material can be applied. Examples include “Teonex” [manufactured by Teijin Chemicals Ltd.], “APEL” [manufactured by Mitsui Chemicals, Inc.], “Heat-Resistant Transparent COC Film, F film” [manufactured by GUNZE LIMITED], “LUCERA” [manufactured by JSR Corporation], polyimide film, “ZEONOR” [manufactured by Zeon Corporation], and the like.

The substrate used in the present invention satisfies the formula (A), but X_{A} in the formula (A) is not dependent on only the thickness or the glass transition temperature of the substrate. The appropriate substrate may be selected by adjusting the thickness and the glass transition temperature of the substrate, and the temperature for drying the liquid crystal coating film, and the like.

### <Orientation Film>

The orientation film has an orientation regulating force that orients liquid crystals in the polymerizable liquid crystal compound described later in a desired direction.

The orientation film facilitates liquid crystal orientation in the polymerizable liquid crystal compound described later. The state of liquid crystal orientation, such as horizontal orientation, perpendicular orientation, hybrid orientation, or inclined orientation, varies depending on the properties of the orientation film and the polymerizable liquid crystal compound, and any combination can be selected. When the orientation film is a material that develops horizontal orientation with its orientation regulating force, the polymerizable liquid crystal compound can form horizontal orientation or hybrid orientation, while when it is a material that develops perpendicular orientation, the polymerizable liquid crystal compound can form perpendicular orientation or inclined orientation. The expressions “horizontal”, “perpendicular”, etc., refer to the direction of the long axis of an oriented polymerizable liquid crystal compound relative to the plane of the substrate. Horizontal orientation means that the oriented polymerizable liquid crystal compound has its long axis in the direction parallel to the plane.

When the orientation film layer is formed from an orienting polymer, the orientation regulating force is adjustable at will in accordance with the surface state or rubbing conditions. When the orientation film is formed from a photo-orienting polymer, the orientation regulating force is adjustable at will in accordance with polarized-light-irradiating conditions and the like. The liquid crystal orientation is also controllable by selecting physical properties of the polymerizable liquid crystal compound such as surface tension and liquid crystal properties.

It is preferable that the orientation film formed between the substrate and the liquid crystal cured film is insoluble in the solvent used in the formation of the liquid crystal cured film on the orientation film and has heat resistance in a heating treatment for the removal of the solvent or the orientation of liquid crystals. Examples of the orientation film include an orientation film made of an orienting polymer, a photo-orientation film, and the like.

The thickness of the orientation film is usually from 10 to 500 nm, and preferably from 10 to 300 nm.

### <Orientation Film Made of Orienting Polymer>

Examples of the orienting polymer include polyamides and gelatins having an amide bond in the molecule, polyimides having an imide bond in the molecule, polyamic acids which are hydrolysates thereof, polyvinyl alcohol, alkyl-modified polyvinyl alcohols, polyacrylamide, polyoxazol, polyethyleneimine, polystyrene, polyvinylpyrrolidone, polyacrylic acid, polyacrylic acid esters, and the like, and polyvinyl alcohol is preferable. These orienting polymers may be used alone or in combination.

An orientation film made of an orienting polymer is usually obtained by applying a composition prepared by dissolving an orienting polymer in a solvent (hereinafter sometimes referred to as an orienting polymer composition) to the substrate, and removing the solvent, or by applying the orienting polymer composition to the substrate, and removing the solvent, followed by rubbing it (rubbing method).

Examples of the solvent include water; alcoholic solvents such as methanol, ethanol, ethylene glycol, isopropyl alcohol, propylene glycol, methyl cellosolve, butyl cellosolve, and propylene glycol monomethyl ether; ester solvents such as ethyl acetate, butyl acetate, ethylene glycol methyl ether acetate, γ-butyrolactone, propylene glycol methyl ether acetate, and ethyl lactate; ketone solvents such as acetone, methyl ethyl ketone, cyclopentanone, cyclohexanone, methyl amyl ketone, and methyl isobutyl ketone; aliphatic hydrocarbon solvents such as pentane, hexane, and heptane; aromatic hydrocarbon solvents such as toluene and xylene; nitrile solvents such as acetonitrile; ether solvents such as tetrahydrofuran and dimethoxyethane; chlorinated hydrocarbon solvents such as chloroform and chlorobenzene; and the like. These solvents may be used alone or in combination.

The concentration of the orienting polymer in the orienting polymer composition should be within the range where the orienting polymer material can completely dissolve in the solvent, and is preferably 0.1 to 20% by mass, and further more preferably 0.1 to 10% by mass, as solids content relative to the solution.

Examples of the commercially available orienting polymer composition include SUNEVER (registered trademark, manufactured by Nissan Chemical Industries, Ltd.), OPTMER (registered trademark, manufactured by JSR Corporation), and the like.

Examples of the method for applying the orienting polymer composition to the substrate include known methods such as coating methods such as a spin coating method, an extrusion method, a gravure coating method, a die coating method, a bar coating method, and an applicator method, and printing methods such as a flexo method.

As a result of the removal of the solvent contained in the orienting polymer composition, a dry film of the orienting polymer is formed. Examples of the method for removing the solvent include a natural drying method, a ventilation drying method, a heat drying method, a reduced-pressure drying method, and the like.

Examples of the method for rubbing include a method in which an orienting polymer film on the substrate surface, which has been formed by applying the orienting polymer composition to the substrate, followed by annealing, is brought into contact with a rotating rubbing roll having a rubbing cloth wound therearound.

### <Photo-Orientation Film>

A photo-orientation film is usually obtained by applying a composition containing a polymer or monomer having a photoreactive group and a solvent (hereinafter, sometimes referred to as a “composition for forming a photo-orientation film”) to the substrate, followed by irradiation with polarized light (preferably, polarized UV). A photo-orientation film is more preferable in that the direction of the orientation regulating force can be controlled at will by selecting the polarization direction of the irradiated polarized light.

A photoreactive group refers to a group that produces a liquid crystal orientation capability in response to irradiation with light. Specifically, in response to irradiation with light, a photoreactive group causes a photoreaction that gives origin to a liquid crystal orientation capability, such as a molecule orientation induction or isomerization reaction, a dimerization reaction, a photocrosslinking reaction, or a photodegradation reaction. As photoreactive groups, those having an unsaturated bond, particularly a double bond, are preferable, and groups having at least one member selected from the group consisting of a carbon-carbon double bond (C═C bond), a carbon-nitrogen double bond (C═N bond), a nitrogen-nitrogen double bond (N═N bond), and a carbon-oxygen double bond (C═O bond) are particularly preferable.

Examples of the photoreactive groups having a C═C bond include a vinyl group, a polyene group, a stilbene group, a stilbazole group, a stilbazolium group, a chalcone group, a cinnamoyl group, and the like. Examples of the photoreactive groups having a C═N bond include groups having the structure of aromatic Schiff base, aromatic hydrazone, or the like. Examples of the photoreactive groups having an N═N bond include an azobenzene group, an azonaphthalene group, an aromatic heterocyclic azo group, a bisazo group, a formazan group, and those having azoxybenzene as the basic structure. Examples of the photoreactive groups having a C═O bond include a benzophenone group, a coumarin group, an anthraquinone group, and a maleimide group. These groups may have substituents such as an alkyl group, an alkoxy group, an aryl group, an allyloxy group, a cyano group, an alkoxycarbonyl group, a hydroxyl group, a sulfonic acid group, and an alkyl halide group.

Photoreactive groups that cause a dimerization reaction or a photocrosslinking reaction are preferable in that they are excellent in orientation property. Among them, a cinnamoyl group and a chalcone group are preferable because photoreactive groups that are involved in photodimerization reaction are preferable, the polarized light irradiation dose required for photo-orientation is relatively small, and also a photo-orientation film having excellent thermal stability and temporal stability is likely to be obtained. As the polymer having a photoreactive group, those having a cinnamoyl group, which have a cinnamic acid structure at a terminal of the polymer side chain, are preferable.

As the solvent for the composition for forming a photo-orientation film, those that dissolve the polymer and monomer having a photoreactive group are preferable, and examples of the solvents include those mentioned above as the solvent for the orienting polymer composition.

The content of the polymer or monomer having a photoreactive group in the composition for forming a photo-orientation film is preferably 0.2% by mass or more, and particularly preferably 0.3 to 10% by mass. The composition for forming a photo-orientation film may contain a polymer material such as polyvinyl alcohol and polyimide, and a photosensitizer, in a range where the characteristics of the photo-orientation film are not significantly damaged.

Examples of the method for applying the composition for forming a photo-orientation film to the substrate include the same methods as for applying the orienting polymer composition to the substrate. The method for removing the solvent from the applied composition for forming a photo-orientation film include the same methods as for removing the solvent from the orienting polymer composition.

Irradiation with polarized light may be a style in which a film resulting from the removal of the solvent from the composition for forming a photo-orientation film applied onto the substrate is directly irradiated with polarized light, or may also be a style in which the substrate side is irradiated with polarized light so that the film is irradiated with the polarized light transmitted therethrough. It is preferable that the polarized light is substantially parallel light. The wavelength of the irradiated polarized light is preferably within a wavelength region where the photoreactive group of the polymer or monomer having a photoreactive group can absorb the light energy. Specifically, UV (ultraviolet ray) at a wavelength of 190 to 400 nm is preferable. Examples of the light source used for the polarized light irradiation include a xenon lamp, a high-pressure mercury lamp, an ultrahigh pressure mercury lamp, a metal halide lamp, and an ultraviolet light laser such as KrF and ArF. A high-pressure mercury lamp, an extra-high pressure mercury lamp or a metal halide lamp is more preferable. These lamps are preferable because the emission intensity of an ultraviolet ray at a wavelength of 313 nm is high. Light from the light source is irradiated through an appropriate polarizer, whereby polarized light can be irradiated. As the polarizer, a polarizing filter, a polarizing prism such as Glan-Thompson or Glan-Taylor, or a wire-grid-type polarizer can be used.

Incidentally, when masking is performed at the time of rubbing or polarized light irradiation, it is also possible to forma plurality of regions (patterns) having different liquid crystal orientation directions.

### <Liquid Crystal Cured Film>

The liquid crystal cured film is obtained by applying a composition for forming a liquid crystal cured film containing a polymerizable liquid crystal compound to the orientation film formed on the substrate to obtain a liquid crystal coating film, and polymerizing the polymerizable liquid crystal compound contained in the liquid crystal coating film.

Polymerization of a polymerizable liquid crystal compound can be performed by a known method for polymerizing a compound having a polymerizable functional group. Specific examples include thermal polymerization and photopolymerization, and photopolymerization is preferred from the viewpoint of ease of polymerization. When a polymerizable liquid crystal compound is polymerized by photopolymerization, it is preferred that a polymerizable liquid crystal compound in a liquid crystal coating film obtained by applying and drying a composition for forming a liquid crystal cured film containing a photopolymerization initiator is set into a liquid crystal phase state, and then photopolymerized while holding the liquid crystal state.

Photopolymerization is usually performed by irradiating with light the dried liquid crystal coating film. The light to be radiated is properly selected depending on the kind of the photopolymerization initiator contained in the liquid crystal coating film, the kind of the polymerizable liquid crystal compound (particularly, the kind of a photopolymerizable group of the polymerizable liquid crystal compound) and the amount thereof, and specific examples include visible light, ultraviolet light, and an active electron beam. Among them, ultraviolet light is preferred, from the viewpoint of ease of controlling progress of the polymerization reaction, and availability of those widely used in the art as a photopolymerization device, and it is preferred to select the kinds of the polymerizable liquid crystal compound and photopolymerization initiator, so as to make photopolymerization by ultraviolet light possible. Also, photoirradiation is performed during polymerization while cooling the liquid crystal coating film by a proper cooling means, whereby polymerization temperature can be controlled. At photopolymerization, a patterned retardation layer can be also obtained by performing masking and development.

The liquid crystal cured film is usually a film cured in the state that the polymerizable liquid crystal compound is oriented, and is preferably a film cured in the state that the polymerizable liquid crystal compound is oriented in the horizontal direction or perpendicular direction with respect to the substrate surface.

The thickness of the liquid crystal cured film is preferably from 0.05 to 5 μm, more preferably from 0.5 to 3 μm, and further more preferably from 1 to 3 μm. The thickness of the liquid crystal cured film can be measured by an interference thickness meter, a laser microscope, or a contact-type thickness meter.

It is preferable that, in the liquid crystal cured film, birefringence Δn(λ) for light having a wavelength of λ nm satisfies a formula (1) and a formula (2). When the liquid crystal cured film satisfies these optical characteristics, uniform polarization conversion is possible over a wide band.

Re(450)/Re(550)≦1.00 (1)

1.00≦Re(650)/Re(550) (2)

wherein Re(450), Re(550) and Re(650) represent front retardation values for the light at wavelengths of 450 nm, 550 nm and 650 nm, respectively.

The front retardation value of the liquid crystal cured film can be adjusted by the thickness of the liquid crystal cured film. The front retardation value is decided by a formula (50), thus Δn(λ) and film thickness d should be adjusted, in order to obtain the desired front retardation value (Re(λ)).

Re(λ)=d×Δn(λ) (50)

wherein Re(λ) represents a front retardation value at a wavelength of λ nm, d represents a film thickness, and Δn(λ) represents a birefringence at a wavelength of λnm.

Birefringence Δn(λ) is obtained by measuring the front retardation value and dividing the front retardation value by the thickness of the liquid crystal cured film. Although specific measurement methods are shown in the examples, at this time, when a film formed on a substrate having no in-plane retardation in itself, such as a glass substrate, is subjected to the measurement, the substantial characteristics of the liquid crystal cured film can be measured.

### <Composition for Forming Liquid Crystal Cured Film>

### <Polymerizable Liquid Crystal Compound>

The composition for forming a liquid crystal cured film contains at least one kind of polymerizable compound, and may contain two or more kinds of polymerizable liquid crystal compounds. The polymerizable liquid crystal compound is a compound having a polymerizable group and also having liquid crystal properties. A polymerizable group means a group that is involved in a polymerization reaction and is preferably a photopolymerizable group. A photopolymerizable group herein is a group that can be involved in a polymerization reaction through an active radical, an acid or the like resulting from the photopolymerization initiator.

Examples of the polymerizable groups include a vinyl group, a vinyloxy group, a 1-chlorovinyl group, an isopropenyl group, a 4-vinylphenyl group, an acryloyloxy group, a methacryloyloxy group, an oxiranyl group, and an oxetanyl group. Among them, an acryloyloxy group, a methacryloyloxy group, a vinyloxy group, an oxiranyl group or an oxetanyl group is preferable, and an acryloyloxy group is more preferable. Liquid crystal properties may be thermotropic liquid crystals or lyotropic liquid crystals, and such thermotropic liquid crystals may be nematic liquid crystals or smectic liquid crystals. Thermotropic nematic liquid crystals are preferable in terms of ease of production.

As the polymerizable liquid crystal compound, a known polymerizable liquid crystal compound (a polymerizable liquid crystal compound different from the compound (A) described later) can be used, and particularly when the optical characteristics satisfying the above formula (1) and formula (2) are imparted, a compound represented by the formula (A) (hereinafter sometimes referred to as a compound (A)) is preferably contained as the polymerizable liquid crystal compound. In this case, the polymerizable liquid crystal compounds may be one kind or in combination of two or more kinds, and at least one kind is preferably the compound (A).

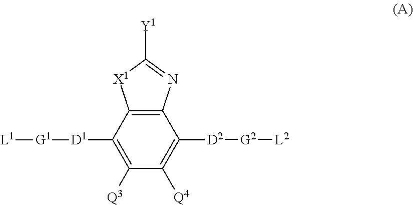

wherein X¹ represents an oxygen atom, a sulfur atom, or —NR¹—, R¹ represents a hydrogen atom or an alkyl group having 1 to 4 carbon atoms,

Y¹ represents an optionally substituted monovalent aromatic hydrocarbon group having 6 to 12 carbon atoms or an optionally substituted monovalent aromatic heterocyclic group having 3 to 12 carbon atoms,

Q³ and Q⁴ each independently represent a hydrogen atom, an optionally substituted monovalent aliphatic hydrocarbon group having 1 to 20 carbon atoms, a monovalent alicyclic hydrocarbon group having 3 to 20 carbon atoms, an optionally substituted monovalent aromatic hydrocarbon group having 6 to 20 carbon atoms, a halogen atom, a cyano group, a nitro group, —NR²R³, or —SR², or Q³ and Q¹ are bonded to each other to form an aromatic ring or a heteroaromatic ring together with the carbon atom to which they are bonded, R² and R³ each independently represent a hydrogen atom or an alkyl group having 1 to 6 carbon atoms,

D¹ and D² each independently represent a single bond, —C(═O)—O—, —C(═S)—O—, —CR⁴R⁵—, —CR⁴R⁵—CR⁶R⁷—, —O—CR⁴R⁵—, —CR⁴R⁵—O—CR⁶R⁷—, —CO—O—CR⁴R⁵—, —O—CO—CR⁴R⁵—, —CR⁴R⁵—O—CO—CR⁶R⁷—, —CR⁴R⁵—CO—O—CR⁶R⁷—, —NR⁴—CR⁵R⁶—, or —CO—NR⁴—,

R⁴, R⁵, R⁶, and R⁷ each independently represent a hydrogen atom, a fluorine atom, or an alkyl group having 1 to 4 carbon atoms,

G¹ and G² each independently represent a divalent alicyclic hydrocarbon group having 5 to 8 carbon atoms. The methylene group constituting the alicyclic hydrocarbon group is optionally substituted with an oxygen atom, a sulfur atom, or —NH—, and the methine group constituting the alicyclic hydrocarbon group is optionally substituted with a tertiary nitrogen atom, and

L¹ and L² each independently represent a monovalent organic group, and at least one of L¹ and L² has a polymerizable group.

In the compound (A), L¹ is preferably a group represented by the formula (A1), and L² is preferably a group represented by the formula (A2).

P¹—F¹—(B¹-A¹)ₖ-E¹- (A1)

P²—F²—(B²-A²)₁-E²- (A2)

wherein B¹, B², E¹ and E² each independently represent —CR⁴R⁵—, —CH₂—CH₂—, —O—, —S—, —OO—O—, —O—CO—O—, —CS—O—, —O—CS—O—, —CO—NR′—, —O—CH₂—, —S—CH₂— or a single bond,

A¹ and A² each independently represent a divalent alicyclic hydrocarbon group having 5 to 8 carbon atoms or a divalent aromatic hydrocarbon group having 6 to 18 carbon atoms, the methylene group constituting the alicyclic hydrocarbon group is optionally substituted with an oxygen atom, a sulfur atom, or —NH—, the methine group constituting the alicyclic hydrocarbon group is optionally substituted with a tertiary nitrogen atom,

k and l each independently represent an integer of 0 to 3,

F¹ and F² each independently represent a divalent aliphatic hydrocarbon group having 1 to 12 carbon atoms,

P¹ represents a polymerizable group,
P² represents a hydrogen atom or a polymerizable group, and

R⁴ and R⁵ each independently represent a hydrogen atom, a fluorine atom, or an alkyl group having 1 to 4 carbon atoms.

A preferred example of the compound (A) is the polymerizable liquid crystal compound described in JP-W-2011-207765.

Examples of a polymerizable liquid crystal compound other than the compound (A) include compounds having a group represented by a formula (X) (hereinafter sometimes referred to as a “compound (X)”).

P¹²—B¹¹-E¹¹-B¹²-A¹¹-B¹³— (X)

wherein P¹¹ represents a polymerizable group,

A¹² represents a divalent alicyclic hydrocarbon group or a divalent aromatic hydrocarbon group, the hydrogen atoms of the divalent alicyclic hydrocarbon group and the divalent aromatic hydrocarbon group are optionally substituted with a halogen atom, an alkyl group having 1 to 6 carbon atoms, an alkoxy group having 1 to 6 carbon atoms, a cyano group or a nitro group, and the hydrogen atoms of the alkyl group having 1 to 6 carbon atoms and the alkoxy group having 1 to 6 carbon atoms are optionally substituted with a fluorine atom,

B¹² represents —O—, —S—, —OO—O—, —O—CO—, —O—CO—O—, —CO—NR¹⁶—, —NR¹⁶—CO—, —CO—, —CS—, or a single bond, R¹⁶ represents a hydrogen atom or an alkyl group having 1 to 6 carbon atoms,

B¹² and B¹³ each independently represent —CH═CH—, —CH₂—CH₂—, —O—, —S—, —C(═O)—C(═O)—O—, —O—C(═O)—, —O—C(═O)—O—, —CH═N—, —N═CH—, —N═N—, —C(═O)—NR¹⁶—, —NR¹⁶—C(═O)—OCH₂—, —OCF₂—, —CH₂O—, —CF₂O—, —CH═CH—C(═O)—O—, —O—C(═O)—CH═CH—, or a single bond,

E¹² represents an alkanediyl group having 1 to 12 carbon atoms, the hydrogen atom of the alkanediyl group is optionally substituted with an alkoxy group having 1 to 5 carbon atoms, and the hydrogen atom of the alkoxy group is optionally substituted with a halogen atom, and —CH₂— constituting the alkanediyl group may be substituted by —O— or —CO—.

Specific examples of the polymerizable liquid crystal compounds include compounds having a polymerizable group out of the compounds described in “Ekisho Binran (Handbook of Liquid Crystals)” (edited by Liquid Crystal Handbook Editorial Committee, Maruzen Publishing Co., Ltd., Oct. 30, 2000), “3.8.6. Network (Fully Cross-Linked)”, “6.5.1. Liquid Crystal Material, b. Polymerizable Nematic Liquid Crystal Material”, as well as the polymerizable liquid crystal compounds described in JP-A-2010-31223, JP-A-2010-270108, JP-A-2011-6360, and JP-A-2011-207765.

The content of the polymerizable liquid crystal compound is usually 70 to 99.5 parts by mass, preferably 80 to 99 parts by mass, more preferably 80 to 94 parts by mass, and further more preferably 80 to 90 parts by mass, based on 100 parts by mass of the solids content of the composition for forming a liquid crystal cured film. In the above range, the orientation properties tend to increase. The solids content herein refers to the total amount of the components of the composition for forming a liquid crystal cured film excluding the solvent.

### <Solvent>

The composition for forming a liquid crystal cured film contains a solvent. It is preferable that the solvent can completely dissolve the polymerizable liquid crystal compound, and it is also preferable that the solvent is inert to the polymerization reaction of the polymerizable liquid crystal compound.

Examples of the solvent include alcoholic solvents such as methanol, ethanol, ethylene glycol, isopropyl alcohol, propylene glycol, ethylene glycol methyl ether, ethylene glycol butyl ether, and propylene glycol monomethyl ether; ester solvents such as ethyl acetate, butyl acetate, ethylene glycol methyl ether acetate, γ-butyrolactone or propylene glycolmethyl ether acetate, and ethyl lactate; ketone solvents such as acetone, methyl ethyl ketone, cyclopentanone, cyclohexanone, 2-heptanone, and methyl isobutyl ketone; aliphatic hydrocarbon solvents such as pentane, hexane, and heptane; aromatic hydrocarbon solvents such as toluene and xylene; nitrile solvents such as acetonitrile; ether solvents such as tetrahydrofuran and dimethoxyethane; and chlorine-containing solvents such as chloroform and chlorobenzene. These solvents may be used alone or in combination.

The content of the solvent is preferably 50 to 98 parts by mass, based on 100 parts by mass of the composition for forming a liquid crystal cured film. The solids content of the composition for forming a liquid crystal cured film is preferably 2 to 50 parts by mass, based on 100 parts by mass of the composition for forming a liquid crystal cured film. When the solids content is 2 parts by mass or less, the composition for forming a liquid crystal cured film has low viscosity, thus the liquid crystal cured film has substantially uniform thickness, and unevenness is unlikely to be generated. The solids content can be determined in consideration of the thickness of the liquid crystal cured film to be produced.

### <Polymerization Initiator>

The composition for forming a liquid crystal cured film preferably contains a polymerization initiator. A polymerization initiator is a compound that can start a polymerization reaction of the polymerizable liquid crystal compound, etc. As the polymerization initiator, photopolymerization initiators that generate an active radical by the action of light are preferable.

Examples of the polymerization initiators include benzoin compounds, benzophenone compounds, alkylphenone compounds, acylphosphine oxide compounds, triazine compounds, iodonium salts, and sulfonium salts.

Examples of the benzoin compounds include benzoin, benzoin methyl ether, benzoin ethyl ether, benzoin isopropyl ether, and benzoin isobutyl ether.

Examples of the benzophenone compounds include benzophenone, methyl o-benzoylbenzoate, 4-phenylbenzophenone, 4-benzoyl-4′-methyldiphenyl sulfide, 3,3′,4,4′-tetra(tert-butylperoxycarbonyl)benzophenone, and 2,4,6-trimethylbenzophenone.

Examples of the alkylphenone compounds include diethoxyacetophenone, 2-methyl-2-morpholino-1-(4-methylthiophenyl)propan-1-one, 2-benzyl-2-dimethylamino-1-(4-morpholinophenyl)butan-1-one, 2-hydroxy-2-methyl-1-phenylpropan-1-one, 1,2-diphenyl-2,2-dimethoxyethan-1-one, 2-hydroxy-2-methyl-1-{4-(2-hydroxyethoxy)phenyl}propan-1-on e, 1-hydroxycyclohexyl phenyl ketone, and an oligomer of 2-hydroxy-2-methyl-1-{4-(1-methylvinyl)phenyl}propan-1-one.

Examples of the acyl phosphine oxide compounds include 2,4,6-trimethylbenzoyldiphenylphosphine oxide and bis(2,4,6-trimethylbenzoyl)phenylphosphine oxide.

Examples of the triazine compounds include 2,4-bis(trichloromethyl)-6-(4-methoxyphenyl)-1,3,5-triazine, 2,4-bis(trichloromethyl)-6-(4-methoxynaphthyl)-1,3,5-triazine, 2,4-bis(trichloromethyl)-6-(4-methoxystyryl)-1,3,5-triazine, 2,4-bis(trichloromethyl)-6-{2-(5-methylfuran-2-yl)ethenyl}-1,3,5-triazine, 2,4-bis(trichloromethyl)-6-{2-(furan-2-yl)ethenyl}-1,3,5-triazine, 2,4-bis(trichloromethyl)-6-{2-(4-diethylamino-2-methylphenyl)ethenyl}-1,3,5-triazine, and 2,4-bis(trichloromethyl)-6-{2-(3,4-dimethoxyphenyl)ethenyl}-1,3,5-triazine.

Examples of commercially available polymerization initiators include “Irgacure (registered trademark) 907”, “Irgacure (registered trademark) 184”, “Irgacure (registered trademark) 651”, “Irgacure (registered trademark) 819”, “Irgacure (registered trademark) 250”, and “Irgacure (registered trademark) 369” (Ciba Japan K.K.); “SEIKUOL (registered trademark) BZ”, “SEIKUOL (registered trademark) Z” and “SEIKUOL (registered trademark) BEE” (Seiko Chemical Co., Ltd.); “Kayacure (registered trademark) BP100” (Nippon Kayaku Co., Ltd.); “Cyracure (registered trademark) UVI-6992” (manufactured by The Dow Chemical Company); “Adeka Optomer SP-152” and “Adeka Optomer SP-170” (ADEKA Corporation); “TAZ-A” and “TAZ-PP” (Nihon Sibel Hegner K.K.); and “TAZ-104” (Sanwa Chemical Co., Ltd.).

When the composition for forming a liquid crystal cured film contains a polymerization initiator, the content of the polymerization initiator is usually 0.1 to 30 parts by mass, preferably 0.5 to 10 parts by mass, and more preferably 0.5 to 8 parts by mass, based on the total amount of 100 parts by mass of the polymerizable liquid crystal compound. It is preferred in the above range since the orientation of the polymerizable liquid crystal compound is not disturbed.

The composition for forming a liquid crystal cured film may contain a sensitizer, a polymerization inhibitor, a leveling agent, and a reactive additive.

### <Sensitizer>

The composition for forming a liquid crystal cured film may contain a sensitizer. A sensitizer can further promote the polymerization reaction of the polymerizable liquid crystal compound.

As the sensitizer, photosensitizers are preferable. Examples of the sensitizers include xanthone compounds such as xanthone and thioxanthone (e.g., 2,4-diethylthioxanthone, 2-isopropylthioxanthone, etc.); anthracene compounds such as anthracene and alkoxy group-containing anthracenes (e.g., dibutoxyanthracene); and phenothiazine and rubrene.

When the composition for forming a liquid crystal cured film contains a sensitizer, the content of the sensitizer is preferably 0.1 to 30 parts by mass, more preferably 0.5 to 10 parts by mass, and further preferably 0.5 to 8 parts by mass, based on the total amount of 100 parts by mass of the polymerizable liquid crystal compound.

### <Polymerization Inhibitor>

The composition for forming a liquid crystal cured film may contain a polymerization inhibitor. The polymerization inhibitor can control the degree of progress of the polymerization reaction of the polymerizable liquid crystal compound.

Examples of the polymerization inhibitors include radical scavengers such as phenolic compounds, sulfur compounds, phosphorus compounds, and amine compounds (different from tertiary amine compounds).

Examples of the phenolic compound include 2,6-di-tert-butyl-4-methylphenol, 2,6-di-tert-butyl-4-ethylphenol, butylhydroxyanisole, hydroquinone, alkoxy group-containing hydroquinones, alkoxy group-containing catechols (e.g., butylcatechol), and pyrogallols. In addition, a commercially available product may be used, and examples include Sumilizer (registered trademark) BHT (2,6-di-t-butyl-4-methylphenol), Sumilizer GM (2-tert-butyl-6-(3-tert-butyl-2-hydroxy-5-methylbenzyl)-4-m ethylphenyl acrylate), Sumilizer GS(F) (2-[1-(2-hydroxy-3,5-di-tert-pentylphenyl)ethyl]-4,6-di-ter t-pentylphenyl acrylate), and Sumilizer GA-80 (3,9-bis[2-{3-(3-tert-butyl-4-hydroxy-5-methylphenyl)propionyloxy}-1,1-dimethylethyl]-2,4,8,10-tetraoxaspiro[5.5]undecane) (all manufactured by Sumitomo Chemical Co., Ltd.).

Examples of the sulfur compound include dialkyl thiodipropionates such as dilauryl thiodipropionate, dimyristyl thiodipropionate, and distearyl thiodipropionate; and Sumilizer TPL-R (dilauryl-3,3′-thiodipropionate) and Sumilizer TPM (dimyristyl-3,3′-thiodipropionate) (all manufactured by Sumitomo Chemical Co., Ltd.), as the commercially available product.

Examples of the phosphorus compound include trioctyl phosphite, trilauryl phosphite, tridecyl phosphite, (octyl)diphenyl phosphite; and Sumilizer GP (6-[3-(3-tert-butyl-4-hydroxy-5-methylphenyl)propoxy]-2,4,8,10-tetra-tert-butyl-dibenzo[d,f][1,3,2]dioxaphosphepin) (manufactured by Sumitomo Chemical Co., Ltd.), as the commercially available product.

The phenolic compound is preferable as a polymerization initiator, in that coloring of the liquid crystal cured film is less.

When the composition for forming a liquid crystal cured film contains a polymerization inhibitor, the content of the polymerization inhibitor is preferably 0.1 to 30 parts, more preferably 0.5 to 10 parts by mass, and further preferably 0.5 to 8 parts by mass, based on the total amount of 100 parts by mass of the polymerizable liquid crystal compound. In the above range, the polymerizable liquid crystal compound can be polymerized without disturbing the orientation of the polymerizable liquid crystal compound. The polymerization inhibitors may be used alone or in combination of two or more kinds.

### <Leveling Agent>

The composition for forming a liquid crystal cured film may contain a leveling agent. A leveling agent functions to adjust the flowability of the composition for forming a liquid crystal cured film, thereby further flattening the film resulting from the application of the composition for forming a liquid crystal cured film, and may be a surfactant. Preferred examples of the leveling agents include leveling agents containing a polyacrylate compound as a main component and leveling agents containing a fluorine-atom-containing compound as a main component.

Examples of the leveling agents containing a polyacrylate compound as a main component include “BYK-350”, “BYK-352” “BYK-353”, “BYK-354”, “BYK-355”, “BYK-358N”, “BYK-361N”, “BYK-380”, “BYK-381”, and“BYK-392” (manufactured by BYK-Chemie GmbH).

Examples of the leveling agents containing a fluorine-atom-containing compound as a main component include “MEGAFACE (registered trademark) R-08” as well as “R-30”, “R-90”, “F-410”, “F-411”, “F-443”, “F-445”, “F-470”, “F-471”, “F-477”, “F-479”, “F-482” and “F-483” (DIC Corporation); “Surflone (registered trademark) S-381” as well as “S-382”, “S-383”, “S-393” “SC-101”, “SC-105”, “KH-40”, and “SA-100” (AGC Seimi Chemical Co., Ltd.); “E1830” and “E5844” (Daikin Fine Chemical Laboratory Co., Ltd.); and “EFTOP EF301” as well as “EF303”, “EF351”, and “EF352” (manufactured by Mitsubishi Materials Electronic Chemicals Co., Ltd.].

When the composition for forming a liquid crystal cured film contains a leveling agent, the content of the leveling agent is preferably 0.01 to 5 parts by mass, and further preferably 0.1 to 3 parts by mass, based on the total amount of 100 parts by mass of the polymerizable liquid crystal compound. It is preferred in the above range since it is easy to horizontally orient the polymerizable liquid crystal compound, and the resulting liquid crystal cured film tends to be smoother. Incidentally, the composition for forming a liquid crystal cured film may contain two or more kinds of leveling agents.

The optically anisotropic film of the present invention can be produced by the process including the following steps (1) to (3). As the substrate in the step (1), a substrate satisfying a formula (A) is used.

Step (1): forming an orientation film layer and a liquid crystal coating layer on a substrate
Step (2): drying the liquid crystal coating layer
Step (3): photoirradiating the liquid crystal coating layer to form a liquid crystal cured film

In the optically anisotropic film obtained by the above production method, the sticking force between the liquid crystal cured film and the orientation film layer or the sticking force between the orientation film layer and the substrate is preferably 0.5 N/25 mm or less, and more preferably 0.3 N/25 mm or less. It is preferred to have a sticking force between the layers of the above value, in that transfer of the liquid crystal cured film and the orientation film to a body to be transferred, or transfer of the liquid crystal cured film to a body to be transferred becomes easy, and the production of the laminated body described later becomes easy.

<Sticking Force Measurement Method>

The sticking force between the liquid crystal cured film and the orientation film layer or the sticking force between the orientation film layer and the substrate can be measured as follows.

A test piece having a width of 25 mm× a length of about 150 mm is cut from the optically anisotropic film, and a sticky adhesive layer is provided on the optically anisotropic film. The sticky adhesive layer side thereof is attached to a glass plate, then using a tensile tester, a lengthwise end of the test piece (one side of the width of 25 mm) is held and subjected to a 90° peel test in accordance with JIS K 6854-1: 1999 “Adhesive, Peel Strength Test Method, Part 1: 90° Peel”, in an atmosphere at a temperature of 23° C. and a relative humidity of 60%, at a crosshead speed (clamp movement speed) of 200 mm/rain.

In addition, the drying temperature (Tₐ) in the step (2) preferably satisfies the following formula (B).

Tₐ≦T_{g}+50° C. (B)

The drying temperature more preferably satisfies the following formula (B1), further preferably satisfies the following formula (B2), and particularly preferably satisfies the following formula (B3).

Tₐ≦T_{g}+45° C. (B1)

Tₐ≦T_{g}+40° C. (B2)

Tₐ≦T_{g}+30° C. (B3)

wherein Tₐ represents a drying temperature, and T_{g} represents a glass transition temperature of the substrate.

The formula (B) is satisfied, whereby it is less likely to cause deformation of the substrate in the step (2), and the formula (A) is more easily satisfied.

When the optically anisotropic film is produced, in the so-called roll-to-roll manner, that continuously carries out the process including the steps (1) to (3), while winding off the substrate from a roll, using the roll of an elongated film as the substrate, it is preferred to apply to the substrate tension P_{B} satisfying the following formula (C) in the direction orthogonal to the carrying direction of the film, in the step (2) or step (3),

0<P_{B}<P_{A}/2 (C)

wherein P_{A} is a tension in a direction parallel to the substrate carrying direction, and P_{B} represents a tension in a direction perpendicular to the substrate carrying direction.

P_{B} is more preferably less than P_{A}/10, and further preferably less than P_{A}/50.

In order to apply a tension in the direction orthogonal to the carrying direction of the film, a system for pulling both ends of the film during carrying using a tenter, a method of using a webguider, and the like are suggested.

It is preferred to satisfy the formula (C), in that generation of stripes on the substrate in a direction parallel to the carrying direction can be even more suppressed, and uniformity of the liquid crystal cured film to be formed can be even more improved.

### <Method for Producing Laminated Body>

A laminated body containing a liquid crystal cured film, a sticky adhesive layer and a body to be transferred in this order can be produced by a step of adhering the liquid crystal cured film and the body to be transferred in the optically anisotropic film with the sticky adhesive layer therebetween, and a step of removing a layer containing the substrate in the optical film.

The sticky adhesive layer may be formed on the liquid crystal cured film or may be formed on the body to be transferred. When the orientation film is present between the substrate and the liquid crystal cured film, the orientation film may be removed together with the substrate.

A substrate having a functional group forming a chemical bond with the orientation film on the surface forms a chemical bond with the orientation film, thus tends to be difficult to remove. Accordingly, when only the substrate is peeled for removal, a substrate with less functional groups on the surface is preferred, and a substrate which is not subjected to a surface treatment for forming a functional group on the surface is preferred.

The orientation film having a functional group forming a chemical bond with the substrate tends to have a large sticking force between the substrate and the orientation film. Thus, when only the substrate is peeled for removal, an orientation film with less functional groups forming a chemical bond with the substrate is preferred. It is preferred that the solution of an orienting polymer composition, a composition for forming a photo-orientation film or the like does not contain a reagent for crosslinking the substrate and the orientation film, and further does not contain a component such as a solvent that dissolves the substrate.

The orientation film having a functional group forming a chemical bond with the liquid crystal cured film tends to have a large sticking force between the liquid crystal cured film and the orientation film. Accordingly, when the orientation film is removed together with the substrate, the orientation film with less functional group forming a chemical bond with the liquid crystal cured film is preferred. It is preferred that the solution of an orienting polymer composition, a composition for forming a photo-orientation film or the like does not contain a reagent for crosslinking the liquid crystal cured film and the orientation film.

### <Sticky Adhesive Layer>

The sticky adhesive layer is formed from a sticky adhesive. Examples of the sticky adhesive include pressure-sensitive adhesives, dry-solidification-type adhesives, and chemical-reaction-type adhesives. Examples of the chemical-reaction-type adhesives include active-energy-ray-curable adhesives.

### <Pressure-Sensitive Adhesive>

A pressure-sensitive adhesive usually contains a polymer and may also contain a solvent.

Examples of the polymer include acrylic polymers, silicone-based polymers, polyester, polyurethane, or polyether. Among them, an acrylic pressure-sensitive adhesive containing an acrylic polymer has excellent optical transparency, moderate wettability and cohesive strength, excellent adhesion, and high weather resistance, heat resistance, and the like, and is also resistant to lifting, peeling, or the like under heating or moistening conditions, thus is preferable.

A preferred example of the acrylic polymer is a copolymer of a (meth)acrylate in which the alkyl group of its ester moiety is an alkyl group having 1 to 20 carbon atoms such as a methyl group, an ethyl group, or a butyl group (hereinafter, an acrylate and a methacrylate are sometimes collectively referred to as a (meth)acrylate, and acrylic acid and methacrylic acid are sometimes collectively referred to as (meth)acrylic acid) and a (meth)acrylic monomer having a functional group such as (meth)acrylic acid or hydroxyethyl(meth)acrylate.

A pressure-sensitive adhesive containing such a copolymer has excellent pressure-sensitive adhesion and, at the time of removal after attachment to a display device, can be removed relatively easily without leaving a paste residue or the like on the display device or the like, thus is preferable. The glass transition temperature of the acrylic polymer is preferably 25° C. or less, and more preferably 0° C. or less. The weight average molecular weight of such an acrylic polymer is preferably 100,000 or more.

Examples of the solvent include those mentioned above as the solvent for the orienting polymer composition.

The thickness of the sticky adhesive layer formed from the pressure-sensitive adhesive is not particularly limited and determined according to its sticking force or the like, but is usually 1 to 40 μm. The thickness is preferably 3 to 25 μm, in terms of workability, durability, and the like. The thickness of the sticky adhesive layer formed from the pressure-sensitive adhesive is 3 to 25 μm, whereby, when the optically anisotropic film is incorporated in the display device, the brightness of the display device as seen from the front or at an angle can be maintained, and also the display image can be prevented from blurring, being unclear, or the like.

### <Dry-Solidification-Type Adhesive>

A dry-solidification-type adhesive may contain a solvent. Examples of the dry-solidification-type adhesives include polymers of monomers having a protonic functional group such as a hydroxyl group, a carboxy group or an amino group, and an ethylenically unsaturated group. Examples also include compositions containing a urethane resin as a main component and further containing a crosslinking agent or a curable compound such as polyaldehyde, an epoxy compound, an epoxy resin, a melamine compound, a zirconia compound or a zinc compound.

Examples of the polymers of monomers having a protonic functional group such as a hydroxyl group, a carboxy group or an amino group, and an ethylenically unsaturated group include an ethylene-maleic acid copolymer, an itaconic acid copolymer, an acrylic acid copolymer, an acrylamide copolymer, a saponified product of polyvinyl acetate, and a polyvinyl alcohol resin.

Examples of the polyvinyl alcohol resins include polyvinyl alcohol, partially saponified polyvinyl alcohol, fully saponified polyvinyl alcohol, carboxyl-group-modified polyvinyl alcohol, acetoacetyl-group-modified polyvinyl alcohol, methylol-group-modified polyvinyl alcohol, and amino-group-modified polyvinyl alcohol. The content of the polyvinyl alcohol resin in an aqueous adhesive is usually 1 to 10 parts by weight, and preferably 1 to 5 parts by mass, based on 100 parts by mass of water.

Examples of the urethane resins include polyester-based ionomer-type urethane resins.

A polyester-based ionomer-type urethane resin herein is a urethane resin having a polyester backbone with a small amount of ionic component (hydrophilic component) introduced thereinto. Such an ionomer-type urethane resin emulsifies in water without using an emulsifier and forms an emulsion, and thus an aqueous adhesive can be obtained. In the case where the polyester-based ionomer-type urethane resin is used, it is effective to incorporate a water-soluble epoxy compound as a crosslinking agent.

Examples of the epoxy resins include polyamide epoxy resins. Examples of commercially available products of such polyamide epoxy resins include “Sumirez Resin 650” and “Sumirez Resin 675” manufactured by Sumika Chemtex Co., Ltd., and “WS-525” manufactured by Japan PMC Co., Ltd. In the case where the epoxy resin is incorporated, the amount to be added is usually 1 to 100 parts by mass, and preferably 1 to 50 parts by mass, based on 100 parts by mass of the polyvinyl alcohol resin.

The thickness of the sticky adhesive layer formed from the dry-solidification-type adhesive is usually 0.001 to 5 μm, preferably 0.01 to 2 μm, and further preferably 1 μm or less. When the sticky adhesive layer formed from the dry-solidification-type adhesive is too thick, the resulting liquid crystal cured film is likely to have poor appearance.

### <Active-Energy-Ray-Curable Adhesive>

An active-energy-ray-curable adhesive may contain a solvent.

An active-energy-ray-curable adhesive is an adhesive that cures by receiving irradiation with an active energy ray.

Examples of the active-energy-ray-curable adhesives include cation-polymerizable adhesives containing an epoxy compound and a cationic polymerization initiator, radical-polymerizable adhesives containing an acrylic curing component and a radical polymerization initiator, those containing both a cation-polymerizable curing component such as an epoxy compound, and a radical-polymerizable curing component such as an acrylic compound, and further containing a cationic polymerization initiator and a radical polymerization initiator, and those that contain no polymerization initiator and is cured by being irradiated with an electron beam. Radical-polymerizable active-energy-ray-curable adhesives containing an acrylic curing component and a radical polymerization initiator are preferable. In addition, cation-polymerizable active-energy-ray-curable adhesives containing an epoxy compound and a cationic polymerization initiator, which can be used with substantially no solvent, are preferable.

Examples of the epoxy compounds include a glycidyl-etherified product of an aromatic compound having a hydroxyl group or linear compound, a glycidyl-aminated product of a compound having an amino group, an epoxidized product of a linear compound having a C═C double bond, and an alicyclic epoxy compound having a glycidyloxy group or epoxyethyl group bonded to the saturated carbon ring directly or via alkylene or having an epoxy group bonded directly to the saturated carbon ring. These epoxy compounds may be used alone or in combination. Among them, alicyclic epoxy compounds have excellent cationic polymerization properties and thus are preferable.

Examples of commercially available products of the epoxy compound include the “jER” series manufactured by Mitsubishi Chemical Corporation, “EPICLON” manufactured by DIC Corporation, “EPOTOHTO (registered trademark)” manufactured by Tohto-Kasei Co., Ltd. “Adeka Resin (registered trademark)” manufactured by ADEKA Corporation, “Denacol (registered trademark)” manufactured by Nagase ChemteX Corporation, “Dow Epoxy” manufactured by The Dow Chemical Company, and “TEPIC (registered trademark)” manufactured by Nissan Chemical Industries, Ltd. Examples of the alicyclic epoxy compounds include the “Celloxide” series and “Cyclomer” manufactured by Daicel Corporation, and the “CYRACURE UVR” series manufactured by The Dow Chemical Company.

The active-energy-ray-curable adhesive containing an epoxy compound may further contain compounds other than the epoxy compound. Examples of the compounds other than the epoxy compound include oxetane compounds and acryl compounds. Among them, it is preferable to use an oxetane compound together because it may increase the curing rate in cationic polymerization.

Examples of the oxetane compounds include the “ARONOXETANE (registered trademark)” series manufactured by Toagosei Co., Ltd. and the “ETERNACOLL (registered trademark)” series manufactured by Ube Industries, Ltd.

It is preferable that the active-energy-ray-curable adhesive containing an epoxy compound or an oxetane compound is used in the absence of solvent.

A cationic polymerization initiator is a compound that generates cationic species by receiving irradiation with an active energy ray such as ultraviolet ray. Examples thereof include aromatic diazonium salts; onium salts such as aromatic iodonium salts and aromatic sulfonium salts; and iron-arene complexes. These cationic polymerization initiators may used alone or in combination.

Examples of commercially available products of the cationic polymerization initiator include the “KAYARAD (registered trademark)” series manufactured by Nippon Kayaku Co., Ltd., the “CYRACURE UVI” series manufactured by The Dow Chemical Company, the“CPI” series manufactured by San-Apro Ltd., “TAZ”, “BBI” and “DTS” manufactured by Midori Kagaku Co., Ltd., the “Adeka Optomer” series manufactured by ADEKA Corporation, and “RHODORSIL (registered trademark)” manufactured by Rhodia.

The content of the cationic polymerization initiator in the active-energy-ray-curable adhesive is usually 0.5 to 20 parts by mass, and preferably 1 to 15 parts by mass, based on 100 parts by mass of the active-energy-ray-curable adhesive.

Examples of the acrylic curing components include (meth)acrylates such as methyl(meth)acrylate and hydroxyethyl(meth)acrylate, and (meth)acrylic acid.

Examples of the radical polymerization initiators include hydrogen-abstraction-type photoradical generators and cleavage-type photoradical generators.

Examples of the hydrogen-abstraction-type photoradical generators include naphthalene derivatives such as 1-methylnaphthalene, anthracene derivatives, pyrene derivatives, carbazole derivatives, benzophenone derivatives, thioxanthone derivatives, and coumarin derivatives.

Examples of the cleavage-type photoradical generators include arylalkyl ketones such as benzoin ether derivatives and acetophenone derivatives, oximeketones, acylphosphineoxides, S-phenylthiobenzoates, titanocenes, and high-molecular-weight derivatives thereof.

Among the cleavage-type photoradical generators, acylphosphine oxides are preferable. Specifically, trimethylbenzoyl diphenylphosphine oxide (trade name: “DAROCURE TPO”; Ciba Japan K.K.), bis(2,6-dimethoxy-benzoyl)-(2,4,4-trimethyl-pentyl)-phosphine oxide (trade name: “CGI 403”; Ciba Japan K.K.), or bis(2,4,6-trimethylbenzoyl)-2,4-dipentoxyphenylphosphine oxide (trade name: “Irgacure 819”; Ciba Japan K.K.) is preferable.

The active-energy-ray-curable adhesive may contain a sensitizer.

The content of the sensitizer is preferably 0.1 to 20 parts by mass, based on 100 parts by mass of the active-energy-ray-curable adhesive.

The active-energy-ray-curable adhesive may further contain an ion-trapping agent, an antioxidant, a chain transfer agent, a tackifier, a thermoplastic resin, a filler, a flow modifier, a plasticizer, a defoaming agent, and the like.

In the present invention, an active energy ray is defined as an energy ray that can decompose a compound generating an active species to generate the active species. Examples of such active energy rays include visible light, an ultraviolet ray, an infrared ray, X-rays, α-rays, β-rays, γ-rays, and an electron beam, and an ultraviolet ray or electron beam is preferable.

The accelerating voltage for electron beam irradiation is usually 5 to 300 kV, and preferably 10 to 250 kV. The exposure dose is usually 5 to 100 kGy, and preferably 10 to 75 kGy.

Electron beam irradiation is usually performed in an inert gas, but may also be performed in the atmosphere or under the condition that a small amount of oxygen is introduced. The irradiation intensity of the ultraviolet ray is usually 10 to 5000 mW/cm². The irradiation intensity of the ultraviolet ray is preferably in a wavelength region effective in the activation of a cationic polymerization initiator or a radical polymerization initiator. It is preferable that irradiation is performed at such a light irradiation intensity once or multiple times to an integrated light quantity of 10 mJ/cm² or more, and preferably 10 to 5,000 mJ/cm².

The light source of the ultraviolet ray may be a low-pressure mercury lamp, a medium-pressure mercury lamp, a high-pressure mercury lamp, an ultrahigh-pressure mercury lamp, a xenon lamp, a halogen lamp, a carbon-arc lamp, a tungsten lamp, a gallium lamp, an excimer laser, an LED light source that emits light in a wavelength range of 380 to 440 nm, a chemical lamp, a black light lamp, a microwave-excited mercury lamp, or a metal halide lamp.

The thickness of the sticky adhesive layer formed from the active-energy-ray-curable adhesive is usually 0.001 to 5 μm, preferably 0.01 μm or more, preferably 4 μm or less, and further preferably 3 μm or less. When the sticky adhesive layer formed from the active-energy-ray-curable adhesive is too thick, the resulting liquid crystal cured film is likely to have poor appearance.

### <Primer Layer>

The present optically anisotropic film may have a primer layer between the liquid crystal cured film and the sticky adhesive layer.

The primer layer usually contains a transparent resin and is formed from a transparent resin solution. The primer layer can suppress defects in the liquid crystal cured film upon the formation of the sticky adhesive layer. As the transparent resin, those having excellent coating properties as well as excellent transparency and adhesiveness after the formation of the primer layer are preferable.

A solvent for the transparent resin solution is selected according to the solubility of the transparent resin. Examples of the solvent include water; aromatic hydrocarbon solvents such as benzene, toluene, and xylene; ketone solvents such as acetone, methyl ethyl ketone, and methyl isobutyl ketone; ester solvents such as ethyl acetate and isobutyl acetate; chlorinated hydrocarbon solvents such as methylene chloride, trichloroethylene, and chloroform; and alcohol solvents such as ethanol, 1-propanol, 2-propanol, and 1-butanol. When the primer layer is formed using a transparent resin solution containing an organic solvent, the optical characteristics of the liquid crystal cured film may be affected, thus the solvent is preferably water.

The transparent resin is preferably an epoxy resin. The epoxy resin may be a one-component curable resin or a two-component curable resin. Water-soluble epoxy resins are particularly preferable. Examples of the water-soluble epoxy resins include polyamide epoxy resins. Examples of commercially available products of the polyamide epoxy resin include Sumirez Resin (registered trademark) 650 (30) and Sumirez Resin (registered trademark) 675 sold by Sumika Chemtex Co., Ltd.

In the case where the water-soluble epoxy resin is used as the transparent resin, in order to further improve coating properties, it is preferable to use it in combination with other water-soluble resins such as polyvinyl alcohol resins. The polyvinyl alcohol resins may be modified polyvinyl alcohol resins, such as partially saponified polyvinyl alcohol, fully saponified polyvinyl alcohol, carboxyl-group-modified polyvinyl alcohol, acetoacetyl-group-modified polyvinyl alcohol, methylol-group-modified polyvinyl alcohol, and amino-group-modified polyvinyl alcohol. Examples of appropriate commercially available products of the polyvinyl alcohol resin include KL-318 (trade name) sold by Kuraray Co., Ltd., which is an anionic group-containing polyvinyl alcohol.

In the case where the primer layer is formed from a solution containing a water-soluble epoxy resin, the content of the epoxy resin is preferably 0.2 to 1.5 parts by mass, based on 100 parts by mass of water. In the case where a polyvinyl alcohol resin is incorporated into this solution, the amount is preferably 1 to 6 parts by mass, based on 100 parts by mass of water. The thickness of the primer layer is preferably 0.1 to 10 μm.

The method for forming the primer layer is not limited, and various known coating methods such as a direct-gravure method, a reverse-gravure method, a die coating method, a comma coating method and a bar coating method can be used.

The sticky adhesive layer is formed by applying a sticky adhesive to the surface of the liquid crystal cured film or the primer layer. In the case where the sticky adhesive contains a solvent, the layer is formed by applying the sticky adhesive to the surface of the liquid crystal cured film or the primer layer, and then removing the solvent. The corona treatment can further improve the adhesiveness between the liquid crystal cured film or the primer layer and the sticky adhesive layer.

The method for applying the sticky adhesive may be the same as those mentioned as methods for applying the orienting polymer composition to the substrate. The method for removing the solvent from the applied sticky adhesive may be the same as those mentioned as methods for removing the solvent from the orienting polymer composition.

### <Body to Be Transferred>

Examples of the body to be transferred include those same as the substrate described above, a polarizer, and a polarizing plate.

### <Polarizer and Polarizing Plate>

A polarizer has a polarization function. Examples of the polarizer include a stretched film having a pigment having absorption anisotropy adsorbed thereto, and a film coated with a pigment having absorption anisotropy. Examples of the pigment having absorption anisotropy include dichroic pigments.

The stretched film having a pigment having absorption anisotropy adsorbed thereto is usually produced through a step of uniaxially stretching a polyvinyl alcohol resin film, a step of dyeing the polyvinyl alcohol resin film with a dichroic pigment to adsorb the dichroic pigment, a step of treating the polyvinyl alcohol resin film having the dichroic pigment adsorbed thereto with an aqueous boric acid solution, and a step of washing with water after the treatment with the aqueous boric acid solution.

The polyvinyl alcohol resin film is subjected to uniaxial stretching, dyeing with a dichroic pigment, a boric acid treatment, washing with water and drying as described above, and the obtained polarizer preferably has a thickness of 5 to 40 μm.

Examples of the film coated with a pigment having absorption anisotropy is painted include a film coated with a composition containing a dichroic pigment having a liquid crystal property, or a composition containing a dichroic pigment and a polymerizable liquid crystal compound.

The film coated with a pigment having absorption an isotropy is preferably thin, but when it is too thin, the strength tends to decrease, resulting in poor workability. The thickness of the film is usually 20 μm or less, preferably 5 μm or less, and more preferably 0.5 to 3 μm.

Specific examples of the film coated with a pigment having absorption anisotropy include films described in JP-A-2012-33249.

A transparent protection film is laminated on at least one surface of the polarizer with an adhesive interposed therebetween to obtain a polarizing plate. As the transparent protection film, a transparent film similar to the above-described substrate is preferred.

### <Circularly Polarizing Plate>

When the body to be transferred is a polarizer or a polarizing plate, and the liquid crystal cured film is a liquid crystal cured film cured in the state that the polymerizable liquid crystal compound is oriented in the horizontal direction with respect to the substrate surface, the laminated body corresponds to a circularly polarizing plate. A sticky adhesive layer is newly provided on the liquid crystal cured film or orientation film after removing the layer containing the substrate, whereby a circularly polarizing plate having the sticky adhesive layer can be also produced.

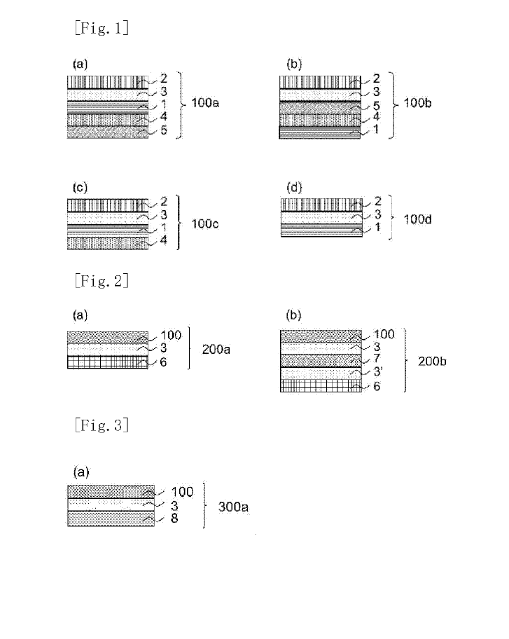

Specific examples of the circularly polarizing plate include a circularly polarizing plate shown in FIG. 1(a) or FIG. 1(b). The circularly polarizing plate shown in FIG. 1(a) or FIG. 1 (b) can be produced by adhering an optically anisotropic film with a polarizing film or polarizing plate with sticky adhesive interposed therebetween. The circularly polarizing plate 100a shown in FIG. 1 (a) is a circularly polarizing plate in which a polarization film 2, a sticky adhesive layer 3, a liquid crystal cured film 1, an orientation film layer 4 and a substrate 5 are laminated in this order, and the circularly polarizing plate 100b shown in FIG. 1(b) is a circularly polarizing plate in which a polarization film 2, a sticky adhesive layer 3, a substrate 5, an orientation film layer 4 and a liquid crystal cured film 1 are laminated in this order. The “sticky adhesive” denotes a generic name of an adhesive and/or a pressure-sensitive adhesive.

In addition, a laminated body formed by adopting a polarizing film as a body to be transferred can also form a circularly polarizing plate. Examples include a circularly polarizing plate shown in FIG. 1 (c) or FIG. 1(d). A circularly polarizing plate 100c shown in FIG. 1(c) is a circularly polarizing plate in which a polarization film 2, a sticky adhesive layer 3, a liquid crystal cured film 1 and an orientation film layer 4 are laminated in this order, and a circularly polarizing plate 100d shown in FIG. 1 (d) is a circularly polarizing plate in which a polarization film 2, a sticky adhesive layer 3 and a liquid crystal cured film 1 are laminated in this order.

The circularly polarizing plate adjusts an axial angle between the slow axis of the liquid crystal cured film 1 and the transmission axis of the polarization film 2, according to the use described later. For example, for use in a liquid crystal display device, the axial angle between the slow axis of the liquid crystal cured film 1 and the transmission axis of the polarization film 2 is arranged to be orthogonal or parallel, and for use in an organic electroluminescence (EL) display device, it is preferred that the axial angle between the slow axis of the liquid crystal cured film 1 and the transmission axis of the polarization film 2 is arranged to be approximately 45°.

### <Use>

The liquid crystal cured film and the circularly polarizing plate can be preferably used for various display devices.

A display device is a device having display elements and includes a light-emitting element or a light-emitting device as the light-emitting source. Examples of the display device include a liquid crystal display device, an organic electroluminescence (EL) display device, an inorganic electroluminescence (EL) display device, a touch panel display device, an electron emission display device (a field emission display device (FED, etc.) and a surface-conduction electron-emitter display device (SED)), an electronic paper (a display device using electronic ink or an electrophoretic element), a plasma display device, a projection-type display device (a grating light valve (GLV) display device, a display device with a digital micromirror device (DMD), etc.), and a piezoelectric ceramic display. Liquid crystal display devices include any of transmissive liquid crystal display devices, transflective liquid crystal display devices, reflective liquid crystal display devices, direct-viewing liquid crystal display devices, projection-type liquid crystal display devices, and the like. Such a display device may be a display device that displays two-dimensional images and may also be a stereoscopic display device that displays three-dimensional images. The circularly polarizing plate can be particularly effectively used for an organic electroluminescence (EL) display device and an inorganic electroluminescence (EL) display device, and an optical compensation polarizing plate can be effectively used for a liquid crystal display device and a touch panel display device.

Examples of the liquid crystal display device include liquid crystal display devices 200a and 200b shown in FIGS. 2(a) and 2(b), respectively. In the liquid crystal display device 200a shown in FIG. 2(a), a circularly polarizing plate 100 and a liquid crystal panel 6 are stuck to each other with a sticky adhesive layer 3 interposed therebetween. In the liquid crystal display device 200b shown in FIG. 2(b), a circularly polarizing plate 100, a sticky adhesive layer 3, a retardation film 7, a sticky adhesive layer 3′ and a liquid crystal panel 6 are laminated in this order. When the retardation film 7 is used, the angle of the slow axis of a liquid crystal cured film 1 and the transmission axis of a polarizing film 2 contained in the circularly polarizing plate 100 may be adjusted, depending on characteristics of the retardation film 7.

Examples of the organic electroluminescence (EL) display device include an organic EL display device 300a shown in FIG. 3(a). In the organic EL display device 300a shown in FIG. 3(a), a circularly polarizing plate 100 and an organic EL panel 8 are stuck to each other with a sticky adhesive layer 3 interposed therebetween.

Known members such as backlight not shown in FIG. 2 and FIG. 3 can be properly incorporated into the display device.

### EXAMPLES

Hereinafter, the present invention will be described further in detail by way of examples. In the examples, the symbol “%” and the word“part(s)” denote “% by mass” and “part(s) by mass”, respectively, unless otherwise specified.

### Example 1

### Preparation of Composition for Forming Photo-Orientation Film

The following components were mixed, and the resultant mixture was stirred at 80° C. for 1 hour to yield a composition for forming a photo-orientation film (1). The following photo-orienting material was synthesized by the method described in JP-A-2013-33248.

### Photo-Orienting Material (1 Part):

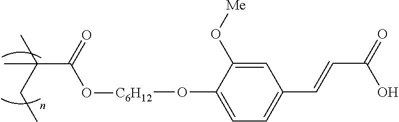

### Solvent (99 Parts): Propylene Glycol Monomethyl Ether

### [Production of Composition for Forming Liquid Crystal Cured Film (1)]

The following components were mixed, and the resultant mixture was stirred at 80° C. for 1 hour to yield a composition for forming a liquid crystal cured film (1).

### Polymerizable Liquid Crystal Compound A1 (80 Parts):

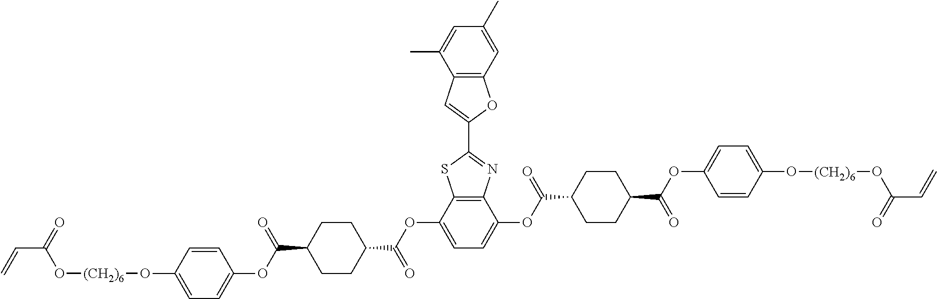

### Polymerizable Liquid Crystal Compound A2 (20 Parts):

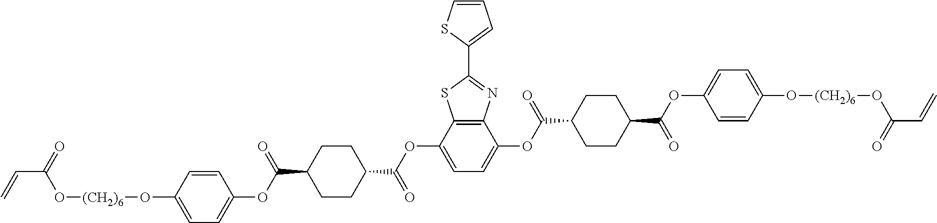

Solvent: N-Methyl-2-pyrrolidinone (160 parts), cyclopentanone (240 Parts)

### Polymerization Initiator (6 Parts):

2-Dimethylamino-2-benzyl-1-(4-morpholinophenyl)butan-1-one (Irgacure 369; manufactured by Ciba Specialty Chemicals Inc.)

Leveling agent (0.1 part): Polyacrylate compound (BYK-361N; manufactured by BYK-Chemie GMbH)

Polymerizable liquid crystal compound A1 and Polymerizable liquid crystal compound A2 were synthesized by the method described in JP-A-2010-31223.

### [Production of Liquid Crystal Cured Film (1)]

The composition for forming a photo-orientation film was applied on a polyethylene terephthalate film (PET) having a thickness of 150 μm, and dried at 80° C. for 1 minute, and then exposed to polarized UV at an integrated light quantity of 100 mJ/cm² using a polarized UV irradiation device (SPOT CURE SP-7; manufactured by Ushio, Inc.). The thickness of the resulting photo-orientation film was measured by a laser microscope (LEXT, manufactured by Olympus Corporation), and found to be 200 μm.

Subsequently, the composition for forming a liquid crystal cured film (1) was applied on the photo-orientation film using a bar coater to obtain a liquid crystal coating film. The liquid crystal coating film was dried at 120° C. for 1 minute, followed by irradiation with ultraviolet ray (integrated light quantity at a wavelength of 365 nm in a nitrogen atmosphere: 1000 mJ/cm²) using a high-pressure mercury lamp (UNICURE VB-15201 BY-A, manufactured by Ushio, Inc.), thereby forming a liquid crystal cured film to obtain an optically anisotropic film (1) in which the substrate, the orientation film and the liquid crystal cured film were laminated in this order.

A pressure-sensitive adhesive is stuck on the liquid crystal cured film of the optically anisotropic film (1), and a cycloolefin polymer film (COP) (ZF-14, manufactured by ZEON CORPORATION) with a corona-treated surface was pressure-bonded to the pressure-sensitive adhesive, followed by removing PET, to obtain a laminated body (1) having the COP, the sticky adhesive layer, and the liquid crystal cured film, in this order.

### [Retardation Value Measurement]

The thickness of the liquid crystal cured film (1) in the laminated body (1) was measured by a laser microscope (LEXT, manufactured by Olympus Corporation). Also, the retardation value of the liquid crystal cured film in the laminated body (1) was measured by KOBRA-WR manufactured by Oji Scientific Instruments. Here, the retardation value of COP at a wavelength of 550 nm is approximately 0, thus does not affect the retardation value of the liquid crystal cured film. The result is shown in Table 1.

### [Surface Shape Measurement of Substrate]

The liquid crystal cured film and the orientation film layer were removed from the optically anisotropic film (1) to obtain PET that is the substrate. The maximum height X_{A}, of every 10 cm² for the resulting PET was measured by non-contact surface layer section shape measuring system (for example, VertScan, manufactured by Hitachi High-Tech Science Corporation). The result is shown in Table 2.

### [Glass Transition Temperature Measurement]

The glass transition temperature T_{g} was measured in a differential scanning calorimetry in accordance with JIS K7121. The result is shown in Table 2.

### <Sticking Force Measurement>

A sticky adhesive layer was laminated to the optically anisotropic film (1), and cut into a test piece having a width of 25 mm× a length of about 150 mm, and the sticky adhesive layer side thereof was attached to a glass plate. Thereafter, using a tensile tester, a lengthwise end of the test piece (one side of the width of 25 mm) was held and subjected to a 90° peel test in accordance with JIS K 6854-1: 1999 “Adhesive, Peel Strength Test Method, Part 1: 90° Peel”, in an atmosphere at a temperature of 23° C. and a relative humidity of 60%, at a crosshead speed (clamp movement speed) of 200 mm/min. The result is shown in Table 2.

### [Confirmation of Unevenness]

An iodine-PVA polarizing plate (SUMIKARAN manufactured by Sumitomo Chemical Co., Ltd., 65 μm thickness) was stuck to the surface of the liquid crystal cured film of the laminated body (1) with a pressure-sensitive adhesive having a thickness of 5 μm interposed therebetween to prepare a circularly polarizing plate (1). The COP side of the circularly polarizing plate (1) was disposed in the mirror surface so that the polarizing plate side could be viewed, and the presence or absence of unevenness was confirmed. The result is shown in Table 2.

### Example 2

A liquid crystal cured film (2) and a laminated body (2) were obtained and evaluated in the same manner as in Example 1, except for changing the substrate to a cycloolefin polymer film (COP) having a thickness of 60 μm. The results are shown in Table 1 and Table 2.

### Example 3

A liquid crystal cured film (3) and a laminated body (3) were obtained and evaluated in the same manner as in Example 1, except for changing the substrate to one obtained by laminating two polyethylene terephthalate films having a thickness of 100 μm with a pressure-sensitive adhesive having a thickness of 38 μm. The results are shown in Table 1 and Table 2.

The thickness of the pressure-sensitive adhesive is not contained in the average thickness dₓ of the substrate dₓ. Namely, dₓ of the substrate laminated with the pressure-sensitive adhesive is 200 μm.

### Reference Example

A liquid crystal cured film and a laminated body were obtained and evaluated in the same manner as in Example 1, except for changing the substrate to a polyethylene naphthalate film (PEN) having a thickness of 100 μm. The glass transition temperature of PEN is 120° C., and the liquid crystal cured film and the laminated body without unevenness can be produced.

### Comparative Example

A liquid crystal cured film (4) and a laminated body (4) were obtained and evaluated in the same manner as in Example 1, except for changing the substrate to a polyethylene terephthalate film having a thickness of 38 μm. The results are shown in Table 1 and Table 2.

TABLE 1

| | Film | | | | | |
|---|---|---|---|---|---|---|
| | thickness | Re | Re | Re | Re (450)/ | Re (650)/ |
| | (μm) | (450) | (550) | (650) | Re (550) | Re (550) |
| Example 1 | 2.3 | 125 | 144 | 148 | 0.87 | 1.03 |
| Example 2 | 2.2 | 122 | 141 | 144 | 0.87 | 1.02 |
| Example 3 | 2.3 | 126 | 143 | 147 | 0.88 | 1.03 |
| Comparative | 2.2 | 125 | 142 | 146 | 0.88 | 1.03 |
| Example | | | | | | |

TABLE 2

| | X_{A} | d_{X}/10 | T_{g} | Sticking force | |
|---|---|---|---|---|---|
| | (μm) | (μm) | (° C.) | (N/25 mm) | Unevenness |
| Example 1 | 0.05 | 15 | 75 | 0.03 | None |
| Example 2 | 0.15 | 6 | 102 | 0.10 | None |
| Example 3 | 0.03 | 20 | 75 | 0.04 | None |
| Comparative | 100 | 3.8 | 75 | 0.03 | Striped |
| Example | | | | | |

The liquid crystal cured films of the examples have no unevenness and are excellent in uniformity after transfer.

According to the present invention, an optically anisotropic film without unevenness can be formed, and an optically anisotropic film also having excellent uniformity in the liquid crystal cured film after transfer can be obtained.

1. An optically anisotropic film formed by laminating a substrate, an orientation film and a liquid crystal cured film in this order, the substrate satisfying the following formula (A),
0<X_{A}<dₓ/10 (A)
wherein X_{A} is a maximum height of the surface irregularity in the substrate, and dₓ represents an average thickness of the substrate.

2. The optically anisotropic film according to claim 1, wherein the substrate has a thickness of 10 to 500 μm.

3. The optically anisotropic film according to claim 1, wherein the substrate has a glass transition temperature (T_{g}) of 90° C. or more.

4. The optically anisotropic film according to claim 1, wherein the liquid crystal cured film has a thickness of 0.05 to 5 μm.

5. The optically anisotropic film according to claim 1, wherein the sticking force between the liquid crystal cured film and the orientation film layer or the sticking force between the orientation film layer and the substrate is 0.5 N/25 mm or less.

6. The optically anisotropic film according to claim 1, wherein the liquid crystal cured film satisfies a formula (1) and a formula (2),
Re(450)/Re(550)≦1.00 (1)
1.00≦Re(650)/Re(550) (2)
wherein Re(450), Re(550) and Re(650) represent in-plane retardation values for the light at wavelengths of 450 nm, 550 nm and 650 nm, respectively.

7. A method for producing an optically anisotropic film comprising laminating a substrate, an orientation film and a liquid crystal cured film in this order, the substrate satisfying the following formula (A),
0<X_{A}<d_{X}/10 (A)
wherein X_{A} is a maximum height of the surface irregularity in the width direction of the substrate, and dₓ represents an average thickness of the substrate,
the method comprising the steps (1) to (3) of
(1) forming an orientation film on a substrate, and forming a liquid crystal coating film on the orientation film;
(2) drying the liquid crystal coating film; and
(3) photoirradiating the liquid crystal coating film to obtain a liquid crystal cured film.

8. The method for producing an optically anisotropic film according to claim 7, wherein the drying temperature (Tₐ) in the step (2) satisfies the following formula (B),
Tₐ≦T_{g}+50° C. (B)
wherein Tₐ represents a drying temperature, and T_{g} represents a glass transition temperature of the substrate.

9. The method for producing an optically anisotropic film according to claim 7, wherein the method continuously carries out the process comprising the steps (1) to (3) while winding off the substrate from a roll, using the roll of an elongated film as the substrate,
the optically anisotropic film being formed by applying tension P_{B} satisfying the following formula (C) in the direction orthogonal to the carrying direction of the film, in the step (2) or step (3),
0<P_{B}<P_{A}/2 (C)
wherein P_{A} is a tension in a direction parallel to the substrate carrying direction, and P_{B} represents a tension in a direction perpendicular to the substrate carrying direction.

10. A method for producing a laminated body containing a liquid crystal cured film, a sticky adhesive layer, and a body to be transferred,
comprising a step of adhering the liquid crystal cured film and the body to be transferred in the optically anisotropic film as defined in claim 1 with the sticky adhesive layer interposed therebetween, and a step of removing a layer containing the substrate in the optical film.

11. A display device equipped with the optically anisotropic film as defined in claim 1.

12. A display device equipped with a laminated body obtained by the method for producing a laminated body as defined in claim 10.
